(19) United States
(12) Patent Application Publication
(10) Pub. No.: US 2019/0297846 A1
(43) Pub. Date: Oct. 3, 2019

(54) Pet Pacifying Environmental Device

(71) Applicants: Boreas Enterprise Co, Ltd., Tainan City (TW); Ten Square Inc., Bethpage, NY (US)

(72) Inventors: Yung-Teng Lo, Tainan City (TW); Feng-Jung Lo, Tainan City (TW); Feng-Yang Lo, Tainan City (TW); Kuo-Lun Lo, Tainan City (TW)

(21) Appl. No.: 15/941,087

(22) Filed: Mar. 30, 2018

(51) Int. Cl. A01K 15/00

(52) U.S. Cl. CPC A01K 15/00

(57) ABSTRACT

A pet pacifying environmental device includes a base, a cover mounted on the base, and a low-frequency radio wave generator mounted between the base and the cover. Thus, the low-frequency radio wave generator produces and transmits a low-frequency electromagnetic wave for pacifying pets so that the pets relax the emotions and release the pressure, so as to achieve the balance of body and mind

### BACKGROUND OF THE INVENTION

### 1. Field of the Invention

The present invention relates to a pacifying device and, more particularly, to a pet pacifying environmental device.

### 2. Description of the Related Art

Many families have kept pets, such as cats, dogs or the like, to enhance the family amusement, and to accompany the family members. However, the pets are generally energetic and love to run around, hop, howl, and so on, so that too many pet activities may hinder the sleep and rest of the family members and affect the normal life and work of the family. On the other hand, the pets, like the human being, may have unsteady conditions, such as anxiety, depression or the like, because of diverse factors, such as lack of the owner's care, shy of strangers, affection of sounds or actions, environmental change of the family or the like, so that the pets easily have harmful behaviors, such as attack, self-mutilation, insulting other animals, hurting the children or the like. However, the people cannot directly talk to or communicate with the pets, so that it is uneasy for the people to appease the pets, to make them quiet, and to stabilize their emotions, so as to prevent violent behaviors.

### BRIEF SUMMARY OF THE INVENTION

The primary objective of the present invention is to provide a pet pacifying environmental device that produces and transmits a low-frequency electromagnetic wave for pacifying pets so that the pets relax the emotions and release the pressure, so as to achieve the balance of body and mind

In accordance with the present invention, there is provided a pet pacifying environmental device comprising a base, a cover mounted on the base, and a low-frequency radio wave generator mounted between the base and the cover. The base includes a base plate, an annular wall formed on a periphery of the base plate, a plurality of posts mounted on the base plate, a positioning block mounted on the base plate, a receiving member mounted on the base plate, and a first restriction piece mounted on the base plate. A predetermined distance is defined between the posts, the positioning block and the receiving member. Each of the posts is provided with a mounting hole. The receiving member is provided with a receiving hole. The first restriction piece is connected with the receiving member. The cover includes a housing, an annular flange formed on a periphery of the housing, a plurality of pillars located in the housing, and a second restriction piece located in the housing. The annular flange of the cover is closely fitted onto the annular wall of the base. The pillars of the cover are juxtaposed to the posts of the base. Each of the pillars of the cover is provided with a fitting hole which is a screw hole aligning with the mounting hole of each of the posts. The cover further includes a plurality of screws each extending through the mounting hole of each of the posts and each screwed into the fitting hole of each of the pillars, so that the pillars of the cover and the posts of the base are combined and secured. The second restriction piece of the cover is movable to contact the first restriction piece of the base. The low-frequency radio wave generator includes a generator body and a connector connected with the generator body. The generator body produces a low-frequency electromagnetic wave having a frequency of about 40-50 hertz. The generator body is secured on the base plate of the base and located between the positioning block, the receiving member and some of the posts of the base. The connector is secured in the receiving hole of the receiving member.

When in use, the generator body is energized and transmits a low-frequency electromagnetic wave to the surrounding environment. When the pet receives the low-frequency electromagnetic wave, the brain of the pet is induced and relaxed, so as to achieve a pacifying effect, so that the pet relaxes, reduces the flush activities and has a steady mood, thereby preventing the pet from interrupting the user's life due to the unsteady emotions, thereby helping the pet leave the negative feeling, such as depression, and thereby preventing the pet presenting harmful behaviors.

In addition, the second restriction piece of the cover is moved to touch the first restriction piece of the base, so that the fitting hole of each of the pillars aligns with the mounting hole of each of the posts, so as to combine the cover and the base easily and quickly, thereby facilitating the user assembling the cover with the base.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a pet pacifying environmental device in accordance with the preferred embodiment of the present invention.

FIG. 2 is a cross-sectional assembly view of the pet pacifying environmental device as shown in FIG. 1.

FIG. 3 is a schematic view showing that the second restriction piece of the cover is spaced from the first restriction piece of the base.

FIG. 4 is a schematic operational view showing that the second restriction piece of the cover is moved to contact the first restriction piece of the base.

### DETAILED DESCRIPTION OF THE INVENTION

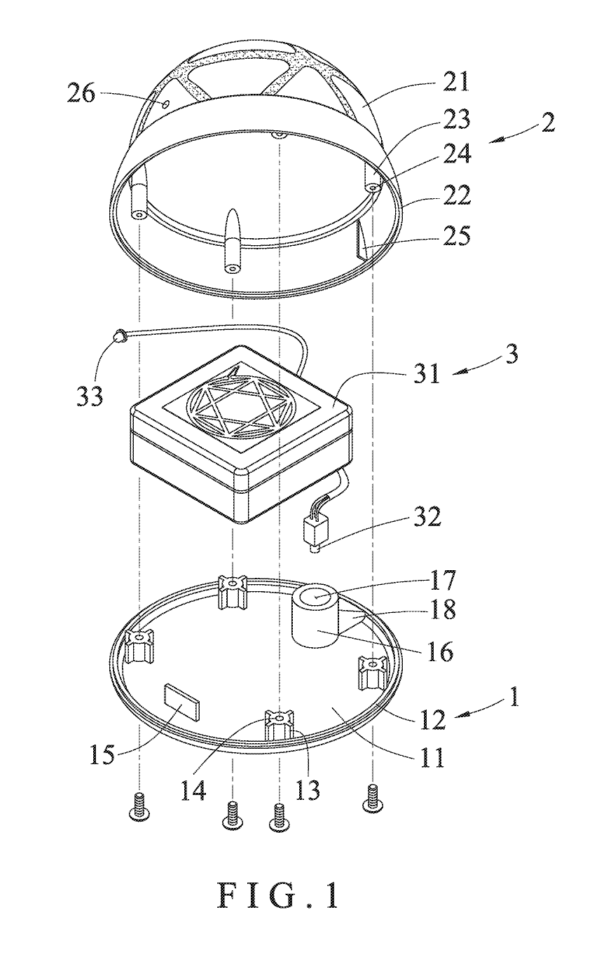

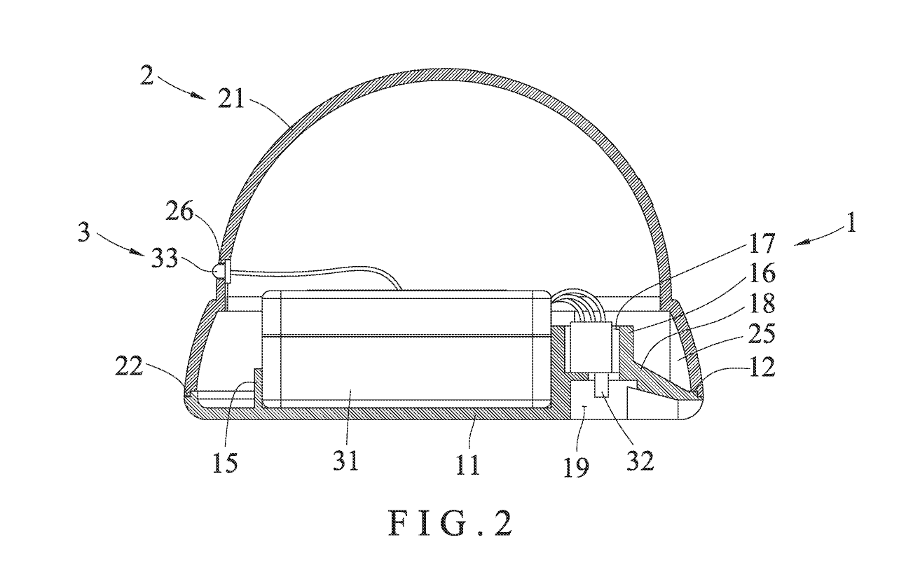

Referring to the drawings and initially to FIGS. 1 and 2, a pet pacifying environmental device in accordance with the preferred embodiment of the present invention comprises a base 1, a cover 2 mounted on the base 1, and a low-frequency radio wave generator 3 mounted between the base 1 and the cover 2.

The base 1 includes a base plate 11, an annular wall 12 formed on a periphery of the base plate 11, a plurality of posts 13 mounted on the base plate 11, a positioning block 15 mounted on the base plate 11, a receiving member 16 mounted on the base plate 11, and a first restriction piece 18 mounted on the base plate 11. A predetermined distance is defined between the posts 13, the positioning block 15 and the receiving member 16. Each of the posts 13 is provided with a mounting hole 14. The receiving member 16 is provided with a receiving hole 17. The first restriction piece 18 is connected with the receiving member 16 and has a height greater than that of the annular wall 12. The posts 13, the positioning block 15, the receiving member 16 and the first restriction piece 18 are encompassed by the annular wall 12. The base plate 11 has a bottom provided with an undercut 19 connected to the receiving hole 17.

The cover 2 includes a housing 21, an annular flange 22 formed on a periphery of the housing 21, a plurality of pillars 23 located in the housing 21, and a second restriction piece 25 located in the housing 21. The annular flange 22 of the cover 2 has an inner diameter equal to an outer diameter of the annular wall 12, so that the annular flange 22 of the cover 2 is closely fitted onto the annular wall 12 of the base 1. The pillars 23 of the cover 2 are juxtaposed to the posts 13 of the base 1. Each of the pillars 23 of the cover 2 is provided with a fitting hole 24 which is a screw hole aligning with the mounting hole 14 of each of the posts 13. The cover 2 further includes a plurality of screws each extending through the mounting hole 14 of each of the posts 13 and each screwed into the fitting hole 24 of each of the pillars 23, so that the pillars 23 of the cover 2 and the posts 13 of the base 1 are combined and secured. The second restriction piece 25 of the cover 2 is movable to contact the first restriction piece 18 of the base 1.

The low-frequency radio wave generator 3 includes a generator body 31 and a connector 32 connected with the generator body 31. The generator body 31 produces a low-frequency electromagnetic wave having a frequency of about 40-50 hertz. The generator body 31 is secured on the base plate 11 of the base 1 and located between the positioning block 15, the receiving member 16 and some (or two) of the posts 13 of the base 1. The connector 32 is secured in the receiving hole 17 of the receiving member 16. Preferably, the connector 32 is a USB (universal serial bus).

In the preferred embodiment of the present invention, the housing 21 of the cover 2 has a surface provided with an aperture 26, and the low-frequency radio wave generator 3 further includes an indication light 33 connected with the generator body 31 and secured in the aperture 26 of the housing 21.

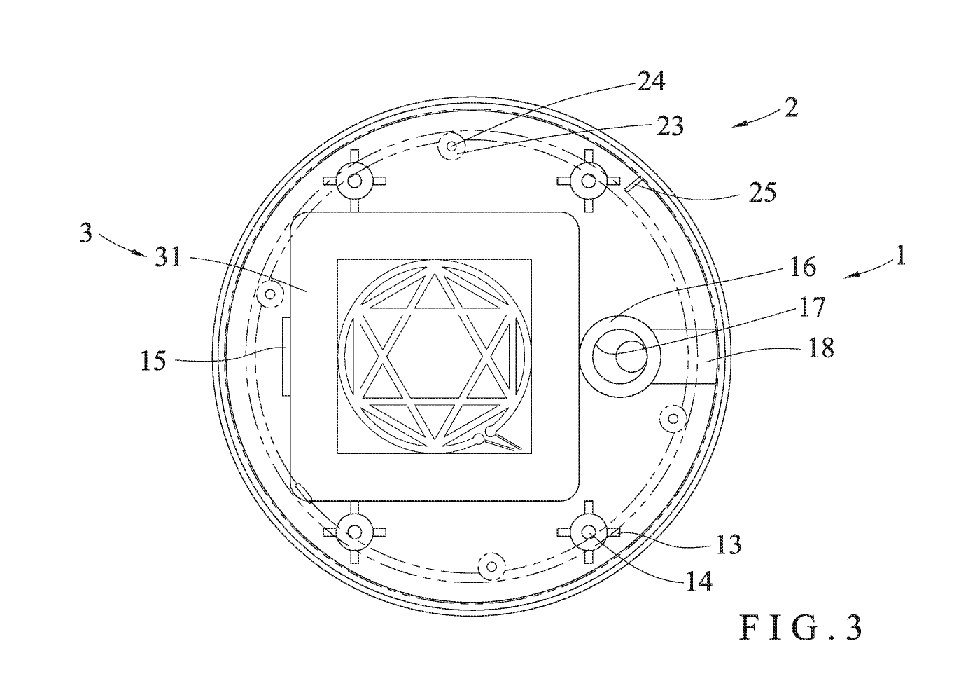

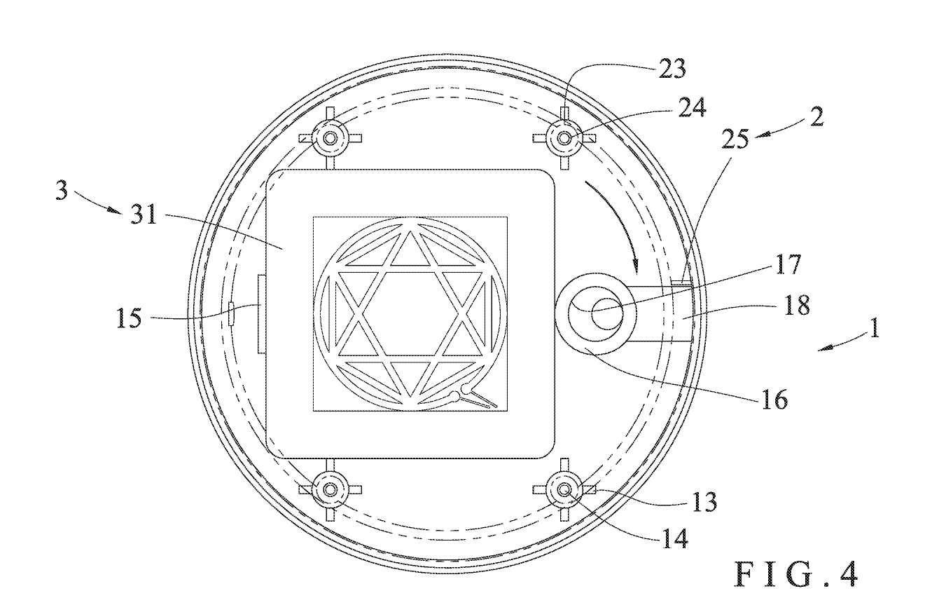

In assembly, referring to FIGS. 3 and 4 with reference to FIGS. 1 and 2, the generator body 31 is sandwiched between the positioning block 15, the receiving member 16 and the posts 13 of the base 1, and is secured on the base plate 11 of the base 1 by sticking or bonding. Then, the connector 32 is secured in the receiving hole 17 of the base 1, and the indication light 33 is secured in the aperture 26 of the cover 2. Then, the annular flange 22 of the cover 2 is closely fitted onto the annular wall 12 of the base 1. When the cover 2 is rotated relative to the base 1 in one predetermined direction (the clockwise direction shown in the figure), the second restriction piece 25 of the cover 2 is moved to contact the first restriction piece 18 of the base 1 as shown in FIG. 4, to stop a further rotation of the cover 2. At this time, when the second restriction piece 25 of the cover 2 touches the first restriction piece 18 of the base 1, the fitting hole 24 of each of the pillars 23 aligns with the mounting hole 14 of each of the posts 13, and each of the screws extends through the mounting hole 14 of each of the posts 13 and is screwed into the fitting hole 24 of one of the pillars 23, so that the pillars 23 of the cover 2 and the posts 13 of the base 1 are combined and secured.

In use, when the connector 32 is electrically connected with an external power supply, the generator body 31 is energized and transmits a low-frequency electromagnetic wave having a frequency of about 40-50 hertz, to produce a comfortable environment for pacifying pets, such as cats, dogs or the like, so as to relax and steady the pets. In addition, the indication light 33 is energized and lights to indicate a normal operation of the generator body 31, so that the user judges operation of the generator body 31.

Accordingly, the low-frequency radio wave generator 3 transmits a low-frequency electromagnetic wave to the surrounding environment to form a stabilized field for pacifying the pets, so as to help the user relax and calm the pets, thereby preventing the pets from having harmful behaviors, such as attack, self-mutilation or the like. In addition, the second restriction piece 25 of the cover 2 is moved to touch the first restriction piece 18 of the base 1, so that the fitting hole 24 of each of the pillars 23 aligns with the mounting hole 14 of each of the posts 13, so as to combine the cover 2 and the base 1 easily and quickly, thereby facilitating the user assembling the cover 2 with the base 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A pet pacifying environmental device comprising:
a base;
a cover mounted on the base; and
a low-frequency radio wave generator mounted between the base and the cover;
wherein:
the base includes a base plate, an annular wall formed on a periphery of the base plate, a plurality of posts mounted on the base plate, a positioning block mounted on the base plate, a receiving member mounted on the base plate, and a first restriction piece mounted on the base plate;
a predetermined distance is defined between the posts, the positioning block and the receiving member;
each of the posts is provided with a mounting hole;
the receiving member is provided with a receiving hole;
the first restriction piece is connected with the receiving member;
the cover includes a housing, an annular flange formed on a periphery of the housing, a plurality of pillars located in the housing, and a second restriction piece located in the housing;
the annular flange of the cover is closely fitted onto the annular wall of the base;
the pillars of the cover are juxtaposed to the posts of the base;
each of the pillars of the cover is provided with a fitting hole which is a screw hole aligning with the mounting hole of each of the posts;
the cover further includes a plurality of screws each extending through the mounting hole of each of the posts and each screwed into the fitting hole of each of the pillars, so that the pillars of the cover and the posts of the base are combined and secured;
the second restriction piece of the cover is movable to contact the first restriction piece of the base;
the low-frequency radio wave generator includes a generator body and a connector connected with the generator body;
the generator body produces a low-frequency electromagnetic wave having a frequency of about 40-50 hertz;
the generator body is secured on the base plate of the base and located between the positioning block, the receiving member and some of the posts of the base; and
the connector is secured in the receiving hole of the receiving member.

2. The pet pacifying environmental device of claim 1, wherein the housing of the cover has a surface provided with an aperture, and the low-frequency radio wave generator further includes an indication light connected with the generator body and secured in the aperture of the housing.

3. The pet pacifying environmental device of claim 1, wherein the connector is a USB (universal serial bus).
